(19) United States
(12) Patent Application Publication
(10) Pub. No.: US 2012/0198074 A1
(43) Pub. Date: Aug. 2, 2012

(54) LOAD BALANCING METHOD

(75) Inventor: Der-Cherng Liaw, Hsinchu City (TW)

(73) Assignee: NATIONAL CHIAO TUNG UNIVERSITY, Hsinchu City (TW)

(21) Appl. No.: 13/353,634

(22) Filed: Jan. 19, 2012

(30) Foreign Application Priority Data
Jan. 28, 2011 (TW) 100103271

(51) Int. Cl. G06F 15/173

(52) U.S. Cl. 709/226

(57) ABSTRACT

This invention provides a load balancing method employing a load balancing device for performing a load balancing for servers, which includes the steps of: calculating a maximum amount of load balancing of the first round and performing load balancing of the first round; and determining whether an actual amount of each server of the first round reaches the maximum amount of load balancing of the first round. The maximum amount of the load balancing at each round is less than or equal to the maximum amount of the load balancing at a previous round, and a sum of the maximum amount of the load balancing at the each round is less than or equal to the full capacity of each server. Thereby, the load balancing can be performed according to the maximum amount of the load balancing at each round to reach a load balancing among the servers.

### FIELD OF THE INVENTION

The present invention relates to a load balancing method, and more particularly, to a load balancing method for processing information traffic in network.

### BACKGROUND OF THE INVENTION

With the advances in technologies, the networking has become one of the most important technique in the modem society. With increasing population in the Internet, loads of servers in the network to respond users' request also increases.

Traditional servers may easily be overloaded. For example, referring to FIG. 1, a flowchart illustrating a method for balancing server load in the prior art. In step S11, a traffic alert value is set for each server. Then in step S12, a load balancer evenly distributes users' request to each server. Then in step S13, when one of the servers reaches its traffic alert value, the server sends a notification to the load balancer to notify the load balancer to stop distribute requests at client end to the server and to direct users' requests to the other servers instead.

However, this approach of evenly distributing the uers' requests at client end to each server will unnecessarily consume a lot of power at server end even if the amount of requests at client end is small, since all servers have to be activated. In addition, the traffic alert value of the server is a threshold that must not be exceeded when the load balancer is performing load balancing; therefore, if all the servers have reached their traffic alert values, then total connection failure will be experienced by users, and the users have to be queued for available space until one of connections has ended. Moreover, a poor setting of the traffic alert value may cause overload, failure, or disconnection in the server, leading to reduction in overall system efficiency.

Therefore, there is a need for a method for load balancing that achieves load balancing among a plurality of servers, prevents server overload, and relieves congestion in users' connections.

### SUMMARY OF THE INVENTION

In the light of forgoing drawbacks, an objective of the present invention is to provide a method for load balancing that performs load balancing to a plurality of servers in a network system.

The load balancing method, employing a load balancing device performing a load balancing for a plurality of servers, comprising the steps of: (1) calculating a maximum amount of a load balancing of a first round for each of the servers based on a full capacity of each of the servers, so as to perform a load balancing of the first round for the servers; (2) determining whether an actual amount of the load balancing of the first round for each of the servers reaches the maximum amount of the load balancing of the first round for each of the servers; if not, performing the load balancing of the first round for the servers in step (1) again; and if yes, proceeding to step (3); (3) calculating a maximum amount of a load balancing of a next round for each of the servers, and performing a load balancing of the next round for the servers; and (4) determining whether an actual amount of the load balancing of the next round for each of the servers reaches the maximum amount of the load balancing of the next round for each of the servers; if not, performing the load balancing of the next round for the servers in step (3); and if yes, calculating a maximum amount of a load balancing of a further next round for each of the servers, and performing a load balancing of the further next round for the servers, wherein the maximum amount of the load balancing for each of the servers at each round is less than or equal to the maximum amount of the load balancing for each of the servers at a previous round, and an accumulated sum of the maximum amounts of the load balancing for each of the servers at each round is less than or equal to the full capacity of each of the servers.

In an embodiment, the maximum amount of the load balancing of the first round for each of the servers is

$$\frac{1}{M}$$

of the servers is of the full capacity of each of the servers, wherein M is a variable parameter. In addition, the full capacity of each of the servers is calculated based on a computing power of a central processing unit, a memory space, a hard disk status of each of the servers, and/or the maximum number of loads connected with the servers.

In another embodiment, the maximum amount of the load balancing of each of the servers at each round is

$$\frac{1}{N}$$

of the full capacity of each of the servers at the previous round, wherein N is a variable parameter.

In an exemplary embodiment, the M and N both equal to 2.

Compared to the prior art, the present invention eliminates the need of turning on servers of the amount more than necessary when there is only a small amount of users' request, thereby achieving load balancing among the plurality of servers.

### BRIEF DESCRIPTION OF THE DRAWINGS

The present invention can be more fully understood by reading the following detailed description of the preferred embodiments, with reference made to the accompanying drawings, wherein:

FIG. 1 is a flowchart illustrating a method for load balancing in the prior art;

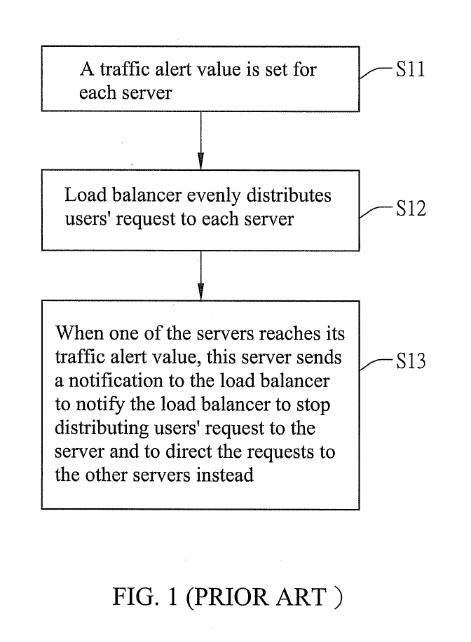

FIG. 2 is a flowchart illustrating a load balancing method according to the present invention;

FIG. 3 is a schematic diagram depicting a specific embodiment of the load balancing method according to the present invention; and

FIG. 4 is a flowchart illustrating the specific embodiment of the load balancing method according to the present invention.

### DETAILED DESCRIPTION OF THE EMBODIMENTS

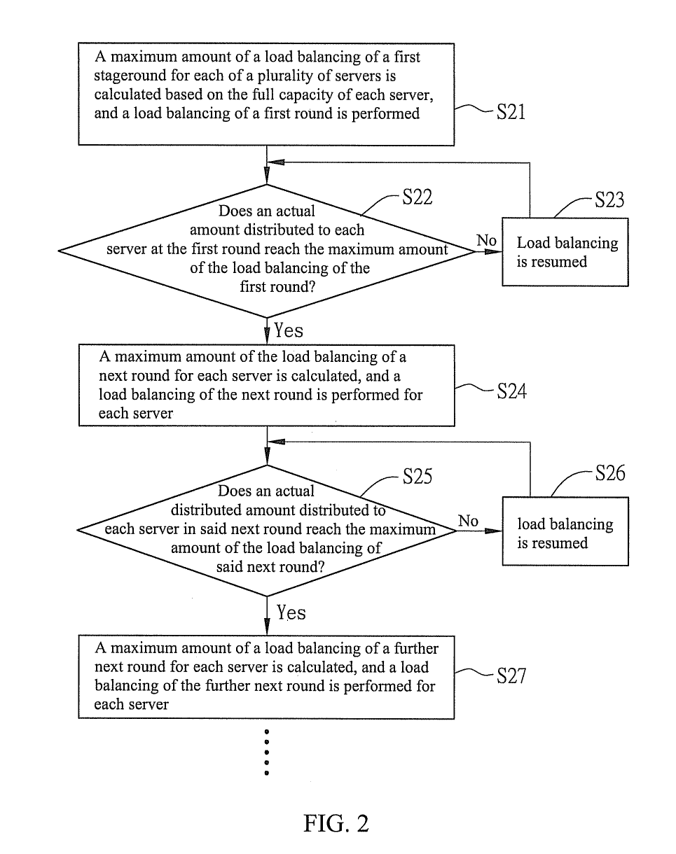

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention. Referring to FIG. 2, a load balancing method according to the present invention includes steps S21 to S27.

In step S21, a maximum amount of a load balancing of a first round for each of a plurality of servers is calculated based on the full capacity of each server, and the load balancing of the first round is performed. More specifically, a load balancing device is used to determine the maximum amount of the load balancing of a first round for each server. In an example, the maximum amount of the load balancing of a first round for a server can be

$$\frac{1}{M}$$

of the full capacity of the server, wherein M is a variable parameter. In a preferred example, M can be 2. In addition, the full capacity of a server can be calculated based on the operational capacity of the CPU, the available memory space, the hard disk status, or other factors. Then, proceed to step S22.

In step S22, it is determined whether an actual distributed amount distributed to each server in the first round satisfies the maximum amount of the load balancing of the first round. In other words, the load limit distributed to each server in the first round by the load balancing device is

$$\frac{1}{M}$$

of the full capacity of the server, and then it is determined whether an actual amount distributed to each server at the first round reaches the maximum amount of the load balancing of the first round; if not, then proceed to step S23; if yes, then proceed to step S24.

In step S23, load balancing is resumed. Then, return to step S22 to perform determination.

In step S24, a maximum amount of the load balancing of a next round for each server is calculated, and a load balancing of the next round is performed for each server, wherein the maximum amount of the load balancing of the next round is less than or equal to the maximum amount of the load balancing of the first round, and an accumulated sum of the maximum amounts of the load balancing of the first and the next round for a server is less than or equal to the full capacity of the server. In an example, the maximum amount of the load balancing of the first round for each server is

$$\frac{1}{M}$$

of the full capacity of each of the servers, and the maximum amount of the load balancing of the next round is

$$\frac{1}{N}$$

of the maximum amount of the load balancing of the first round, wherein N is a variable or N may be equal to M. Then, proceed to step S25.

Then, in step S25, it is determined whether an actual amount distributed to each server in said next round reaches the maximum amount of the load balancing of said next round. In other words, when M equals to N, the load limit distributed to each server in said next round by the load balancing device is

$$\frac{1}{{M}^{2}}$$

of the full capacity of each of the servers; when M does not equal to N,

$$\frac{1}{MN}$$

of the full capacity of each of the servers, and then it is determined whether an actual amount distributed to each server in said next round reaches the maximum amount of the load balancing of said next round; if not, then proceed to step S26; if yes, then proceed to step S27.

In step S26, load balancing is resumed. Then, return to step S25 to perform determination.

In step S27, a maximum amount of the load balancing of a further next round for each server is calculated, and a load balancing of the further next round is performed for each server, and subsequent steps are similarly performed. As a result, the maximum amount of the load balancing of the each round is less than or equal to the maximum amount of the load balancing of a previous round (i.e., a round prior to the each round), and an accumulated sum of the maximum amounts of the load balancing of all the rounds for the each server is less than or equal to the full capacity of the each server, so the server will never be overloaded.

Furthermore, when load balancing is performed, the load balancing device may monitor the plurality of servers to record the maximum amount of the load balancing for each server at each round and obtain the actual amounts distributed to the servers in each round. Moreover, the load balancing device may set or calculate the maximum amount of the load balancing for each server at each round based on different conditions (e.g. based on different hardware performances of the servers).

In addition, load balancing performed in steps S21, S23, S24, S26, and S27 means distributing the load evenly, randomly or based on different conditions to the plurality of servers based on the users' request. Furthermore, the load can be distributed sequentially or selectively to the plurality of servers based on the users' requests. Moreover, when every server has been distributed with a load in a certain round and the load balancing device continues with the load balancing, if the actual amount of one of the servers has dropped below a predetermined threshold, then the load balancing device will distribute the users' request to that server as a first priority, wherein the predetermine threshold may be the allowed maximum capacity of its previous round or the maximum amount of the load balancing initially determined by the load balancing device.

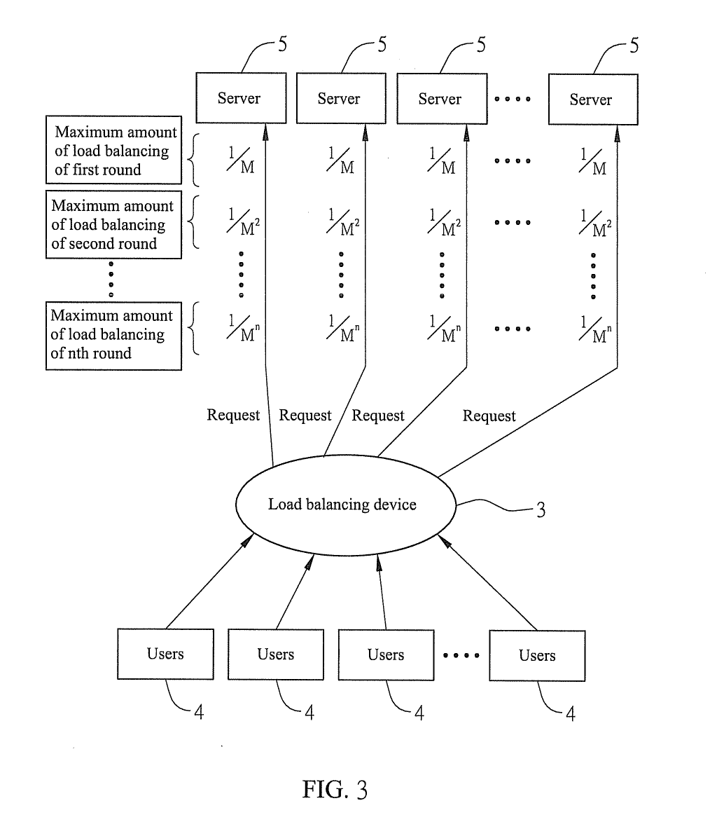

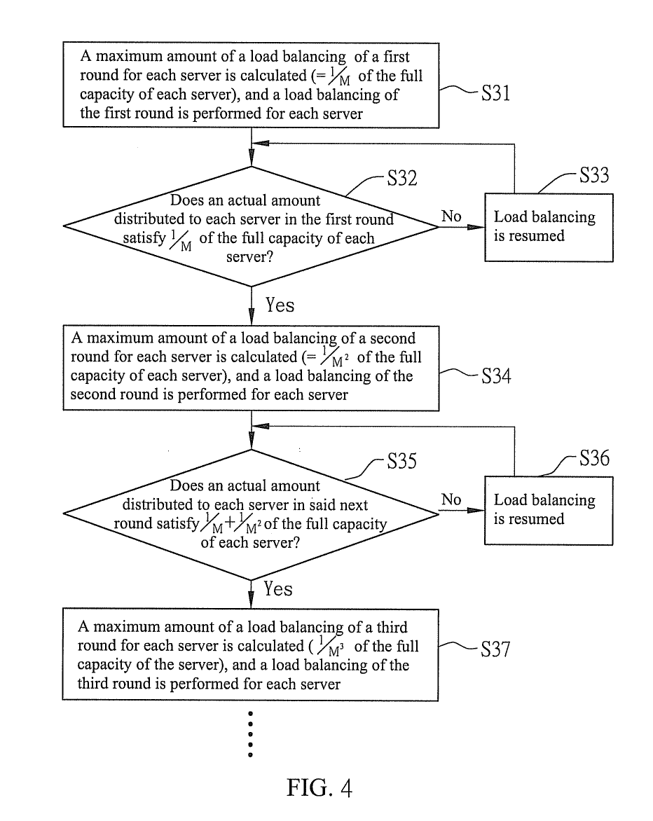

A detailed embodiment of the present invention is discussed with reference to FIGS. 3 and 4. FIG. 3 is a schematic diagram illustrating the load balancing method according to a specific embodiment of the present invention. FIG. 4 is a flowchart illustrating the load balancing method according to the specific embodiment of the present invention.

In step S31, a maximum amount of load balancing of a first round for each of a plurality of servers is calculated or set (to be

$$\frac{1}{M}$$

of the full capacity of each of the servers), and load balancing of the first round is performed for each server based on users' request. Then, proceed to step S32.

In step S32, it is determined whether an actual amount distributed to each server in the first round reaches

$$\frac{1}{M}$$

of the full capacity of each of the servers. If not, then proceed to step S33; if yes, then proceed to step S34.

In step S33, load balancing is resumed. Then, return to step S32.

In step S34, a maximum amount of the load balancing of a second round for each server is calculated or set (to be

$$\frac{1}{{M}^{2}}$$

of the full capacity of each of the servers), that is, making said variables N=M, so the

$$maximum amount of the load balancing of the first round = \frac{1}{M} \cdot ( full capacity ) ,$$

and the

$$maximum amount of the load balancing of the second round = \frac{1}{M} \cdot \frac{1}{M} \cdot ( full capacity ) = \frac{1}{{M}^{2}} \cdot ( full capacity ) ,$$

and load balancing of the second round is performed for each server based on the users' request. Then, proceed to step S35.

Then, in step S35, it is determined whether an actual distributed amount distributed to each server in a second round satisfies

$$\frac{1}{{M}^{2}}$$

of the full capacity of each of the servers. If not, then proceed to step S36; if yes, then proceed to step S37. In other words, if the total amount of loads of each server in the second round reaches

$$( \frac{1}{M} + \frac{1}{{M}^{2}} )$$

of the full capacity of the respective server, then proceed to step S37.

In step S36, load balancing is resumed. Then, return to step S35.

In step S37, a maximum amount of the load balancing of a third round for each server is calculated or set (to be

$$\frac{1}{{M}^{3}}$$

of the full capacity of each of the servers), and a load balancing of the third round is performed for each server based on the requests received from the users. When the total amount of load of each server in the third round reaches

$$( \frac{1}{M} + \frac{1}{{M}^{2}} + \frac{1}{{M}^{3}} )$$

of the full capacity of each of the servers, then a maximum amount of the load balancing of a fourth round for each server is calculated, and so forth.

It can be understood from the specific embodiment shown in FIGS. 3 and 4, the load balancing device distributes the users' request to the plurality of servers, with the maximum amount of the load balancing of each round being less than or equal to the maximum amount of the load balancing of the previous round. For example, when N=M, the maximum amounts of the load balancing of the rounds can be

$$\frac{1}{M} , \frac{1}{{M}^{2}} , \frac{1}{{M}^{3}} , … , \frac{1}{{M}^{n}}$$

of the full capacity of the respective server, respectively, so the accumulated sum of the maximum amount(s) of the load balancing of each of the servers at each round is

$$\frac{1}{M} , ( \frac{1}{M} + \frac{1}{{M}^{2}} ) , ( \frac{1}{M} + \frac{1}{{M}^{2}} + \frac{1}{{M}^{3}} ) , … ( \frac{1}{M} + \frac{1}{{M}^{2}} + \frac{1}{{M}^{3}} + … + \frac{1}{{M}^{n}} )$$

of the full capacity of each of the servers, respectively. As another example, when N=M=2, the variable for the maximum amount of the load balancing at each round is

$$\frac{1}{2} , \frac{1}{4} , \frac{1}{8} , … , \frac{1}{{2}^{n}} ,$$

respectively; when N=M=3, the variable parameter for the maximum amount of the load balancing at each round is

$$\frac{1}{3} , \frac{1}{9} , \frac{1}{27} , … , \frac{1}{{3}^{n}} ,$$

respectively, and the accumulated sum of the maximum amount of the load balancing of the rounds will not exceed the full capacity of each of the servers.

Alternatively, when N≠M, the variable for the maximum amount of the load balancing of each round is

$$\frac{1}{M} , \frac{1}{MN} , \frac{1}{{MN}^{2}} , … , \frac{1}{{MN}^{n - 1}}$$

or other mathematical operations, such as

$$\frac{1}{M} , \frac{1}{MN} , \frac{1}{MN ( N + 1 )} , \frac{1}{MN ( N + 1 ) ( N + 2 )} , … , \frac{1}{MN ( N + 1 ) … ( N + n )} .$$

That is, the maximum amount of the load balancing at each round is limited to less than or equal to the maximum amount of the load balancing of the previous round of the each round, and the accumulated sum of the maximum amounts of the load balancing at each round is thus less than or equal to the full capacity of each of the servers. Accordingly, the loading on each server will never exceed its full capacity.

In summary, the method for load balancing of the present invention calculates the maximum amount of the load balancing of each round, and determines whether the actual amount distributed to each server in each round satisfies the maximum amount of the load balancing in the respective round, wherein the maximum amount of load balancing of each round is less than or equal to the maximum amount of the load balancing at the previous round of the each round, and the accumulated sum of the maximum amounts of load balancing of the each round is thus less than or equal to the full capacity of each of the servers. In addition, the maximum amount of the load balancing of a first round for a server is preferably

$$\frac{1}{M}$$

of the full capacity of each of the servers. M can be determined by the operational capacity of the CPU, the available memory space, the hard disk status of each of the servers, and/or the number of load connected with the servers or other server related information. Therefore, with the present invention, the load of the servers can be more balanced, enhancing efficiency in users' connection.

The above embodiments are only used to illustrate the principles of the present invention, and they should not be construed as to limit the present invention in any way. The above embodiments can be modified by those with ordinary skill in the art without departing from the scope of the present invention as defined in the following appended claims.

What is claimed is:

1. A load balancing method, employing a load balancing device performing a load balancing for a plurality of servers, comprising the steps of:
(1) calculating a maximum amount of a load balancing of a first round for each of the servers based on a full capacity of each of the servers, so as to perform a load balancing of the first round for the servers;
(2) determining whether an actual amount of the load balancing of the first round for each of the servers reaches the maximum amount of the load balancing of the first round for each of the servers; if not, performing the load balancing of the first round for the servers in step (1) again; and if yes, proceeding to step (3);
(3) calculating a maximum amount of a load balancing of a next round for each of the server, so as to perform a load balancing of the next round for the servers; and
(4) determining whether an actual amount of the load balancing of the next round for each of the servers reaches the maximum amount of the load balancing of the next round for each of the servers; if not, performing the load balancing of the next round for the servers in step (3); and if yes, calculating a maximum amount of a load balancing of a further next round for each of the servers, and performing a load balancing of the further next round for the servers, wherein the maximum amount of the load balancing for each of the servers at each round is less than or equal to the maximum amount of the load balancing for each of the servers at a previous round, and an accumulated sum of the maximum amounts of the load balancing for each of the servers at each round is less than or equal to the full capacity of each of the servers.

2. The load balancing method of claim 1, wherein when performing the load balancing, the load balancing device monitors the plurality of servers to record the maximum amount of the load balancing for each of the servers at the each round and to obtain the actual amounts of the load balancing for the servers at the each round.

3. The load balancing method of claim 1, wherein the step of performing load balancing comprises enabling the load balancing device to distribute load to the plurality of servers sequentially based on requests received from users.

4. The load balancing method of claim 1, wherein the full capacity of each of the servers is calculated based on a computing power of a central processing unit, a memory space and a hard disk status of each of the servers, or a number of loads connected with the servers.

5. The load balancing method of claim 1, wherein the maximum amount of the load balancing of the first round for each of the servers is
$$\frac{1}{M}$$
of the full capacity of each of the servers, wherein M is a variable parameter.

6. The load balancing method of claim 5, wherein the maximum amount of the load balancing of each of the servers at each round is
$$\frac{1}{N}$$
of the full capacity of each of the servers at the previous round, wherein N is a variable parameter.

7. The load balancing method of claim 1, wherein when the load balancing device performs the load balancing for a server at a round, if an actual amount of the load balancing for the server at the round drops below the allowed maximum capacity of its previous round, the load balancing device first distributes a user's request to the server.
